(19) United States
(12) Patent Application Publication
(10) Pub. No.: US 2024/0104870 A1
(43) Pub. Date: Mar. 28, 2024

(54) AR Interactions and Experiences

(71) Applicant: Meta Platforms Technologies, LLC, Menlo Park, CA (US)

(72) Inventors: Anna FUSTE LLEIXA, Medford, MA (US); Pol PLA I CONESA, Portland, OR (US); Daniel ROSAS, Auburn, WA (US); Aaron FAUCHER, Torrance, CA (US); Roger IBARS MARTINEZ, Seattle, WA (US); Nathan ASCHENBACH, Seattle, WA (US); Hae Jin LEE, Seattle, WA (US); Jing MA, Mill Creek, WA (US); Ana GARCIA PUYOL, Mountain View, CA (US); Amber CHOO, San Mateo, CA (US)

(21) Appl. No.: 18/532,438

(22) Filed: Dec. 7, 2023

Related U.S. Application Data
(60) Provisional application No. 63/489,516, filed on Mar. 10, 2023.
(60) Provisional application No. 63/489,230, filed on Mar. 9, 2023.
(60) Provisional application No. 63/488,233, filed on Mar. 3, 2023.

(51) Int. Cl. G06T 19/00; G06F 3/01; G06T 15/00

(52) U.S. Cl. CPC G06T 19/006; G06F 3/013; G06F 3/017; G06T 15/00

(57) ABSTRACT

In some implementations, the disclosed systems and methods can detect an interaction with respect to a set of virtual objects, which can start with a particular gesture, and take an action with respect to one or more virtual objects based on a further interaction (e.g., holding the gesture for a particular amount of time, moving the gesture in a particular direction, releasing the gesture, etc.).

In some implementations, the disclosed systems and methods can automatically review a 3D video to determine a depicted user or avatar movement pattern (e.g., dance moves, repair procedure, playing an instrument, etc.).

In some implementations, the disclosed systems and methods can allow the gesture to included a flat hand with the user's thumb next to the palm, with the gesture toward the user's face.

### CROSS REFERENCE TO RELATED APPLICATIONS

This application claims priority to U.S. Provisional Application Numbers 63/488,233 filed Mar. 3, 2023 and titled “Interaction Models for Pinch-Initiated Gestures and Gaze-Targeted Placement,” 63/489,230 filed Mar. 9, 2023 and titled “Artificial Reality Self-View,” and 63/489,516 filed Mar. 10, 2023 and titled “Artificial Reality Tutorials from Three-Dimensional Videos.” Each patent application listed above is incorporated herein by reference in their entireties.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR experiences can be observed by a user through a head-mounted display (HMD), such as glasses or a headset.

Artificial reality (XR) environments can provide immersive video calling experiences that help users feel more connected. In an XR video call, each user can choose how to represent themselves to the other video call users. For example, during an XR video call, a caller user may wish to represent herself as a video, an avatar, a codec avatar, or another type of representation, to a recipient user. The caller user may also want to change and/or control (e.g., move, hide, resize) her representation during the call. These options give the caller user control over her self-presence.

### SUMMARY

Aspects of the present disclosure are directed to interaction models for pinch-initiated gestures and gaze-targeted placement. An artificial reality (XR) device can detect an interaction with respect to a set of virtual objects, which can start with a particular gesture, and take an action with respect to one or more virtual objects based on a further interaction (e.g., holding the gesture for a particular amount of time, moving the gesture in a particular direction, releasing the gesture, etc.). In some implementations, the XR device can further detect gaze of a user to determine where to perform the action with respect to one or more virtual objects of the set.

Further aspects of the present disclosure are directed to artificial reality (XR) tutorials from three-dimensional (3D) videos. Some implementations can automatically review a 3D video to determine a depicted user or avatar movement pattern (e.g., dance moves, repair procedure, playing an instrument, etc.). Some implementations can translate these into virtual objects illustrating the movement patterns. Further, some implementations can cause representations of the virtual objects to be shown to a viewing user on an XR device, such as by projecting foot placement on the floor.

Additional aspects of the present disclosure are directed to generating a self-view of a user (e.g., a caller) in an artificial reality environment. The self-view is generated upon detecting a gesture and a gaze directed at the gesture. In one embodiment, the gesture includes a flat hand with the user's thumb next to the palm, with the gesture toward the user's face. The self-view allows the user to view his or her representation, as seen by a second user (e.g., a recipient), in the artificial reality environment.

### BRIEF DESCRIPTION OF THE DRAWINGS

FIG. 1A is a conceptual diagram of an example view from an artificial reality device of a user performing a pinch gesture and moving her hand up and down to vertically scroll through a photo gallery.

FIG. 1B is a conceptual diagram of an example view from an artificial reality device of a user performing a pinch-and-hold gesture to display a menu of options with respect to a particular photo in a photo gallery.

FIG. 1C is a conceptual diagram of an example view from an artificial reality device of a user performing a pinch-and-release gesture to select a photo from a photo gallery and view it in a zoomed-in mode.

FIG. 1D is a conceptual diagram of an example view from an artificial reality device of a user performing a pinch gesture and moving her hand left and right to horizontally scroll through a photo gallery in a zoomed-in mode.

FIG. 1E is a conceptual diagram of an example view from an artificial reality device of a user performing a pinch-and-peel gesture to peel a copy of a photo from a photo gallery and place it at a location within a real-world environment.

FIG. 1F is a conceptual diagram of an example view from an artificial reality device of a user performing a pinch-and-throw gesture to select a photo from a photo gallery and place it on a wall within a real-world environment.

FIG. 2 is a flow diagram illustrating a process used in some implementations for performing an action in an artificial reality environment using gaze and gesture of a user.

FIG. 3A is a conceptual diagram of an example view on an artificial reality device of an avatar dancing in a three-dimensional video with an option to turn a guide on.

FIG. 3B is a conceptual diagram of an example view on an artificial reality device of a user peeling off a guide from an avatar and placing it on a floor in a real-world environment.

FIG. 3C is a conceptual diagram of an example view on an artificial reality device of a user following a guide to perform a dance alongside an avatar from a three-dimensional video.

FIG. 4 is a flow diagram illustrating a process used in some implementations for generating an artificial reality tutorial from a three-dimensional video.

FIG. 5 is a conceptual diagram of a gaze of a user intersecting with a detected gesture in accordance with some implementations of the present technology.

FIG. 6A is a conceptual diagram of an example artificial reality view with a detected gesture in accordance with some implementations of the present technology.

FIG. 6B is a conceptual diagram of an example artificial reality view displaying a self-view image as a video in response to the detected gesture of FIG. 7A which can be used in some implementations of the present technology.

FIG. 7A is a conceptual diagram of an example artificial reality view displaying a self-view image as an avatar of the user which can be used in some implementation of the present technology.

FIG. 7B is a conceptual diagram of an example artificial reality view displaying the self-view image of FIG. 7A after the user has moved the self-view image.

FIG. 8 is a flow diagram illustrating a process used in some implementations of artificial reality self-view.

FIG. 9A is a wire diagram illustrating a virtual reality headset which can be used in some implementations of the present technology.

FIG. 9B is a wire diagram illustrating a mixed reality headset which can be used in some implementations of the present technology.

FIG. 9C is a wire diagram illustrating controllers which, in some implementations, a user can hold in one or both hands to interact with an artificial reality environment.

FIG. 10 is a block diagram illustrating an overview of devices on which some implementations of the present technology can operate.

FIG. 11 is a block diagram illustrating an overview of an environment in which some implementations of the present technology can operate.

### DESCRIPTION

Aspects of the present disclosure are directed to interaction models for pinch-initiated gestures and gaze-targeted placement. An artificial reality (XR) device can detect an interaction with respect to a library of virtual objects, such as a photo gallery. The interaction can start by a user of the XR device performing a particular gesture, such as a pinch, then performing a further gesture, such as holding the pinch for a particular amount of time, moving the pinch in a particular direction, releasing the pinch in a particular direction, releasing the pinch at a particular point with respect to the initial pinch, etc. The interaction can cause an action with respect to one or more virtual objects within the library, or with respect to the library itself, such as a scrolling action, a selection action, a peeling action, a placement action, a menu display action, etc. In some implementations, the XR device can further detect the gaze of the user during or after performance of the interaction to determine where to perform the action, such as where to start scrolling through the library, which virtual object to select from within the library, to which virtual object a displayed menu pertains, where to place the virtual object, etc.

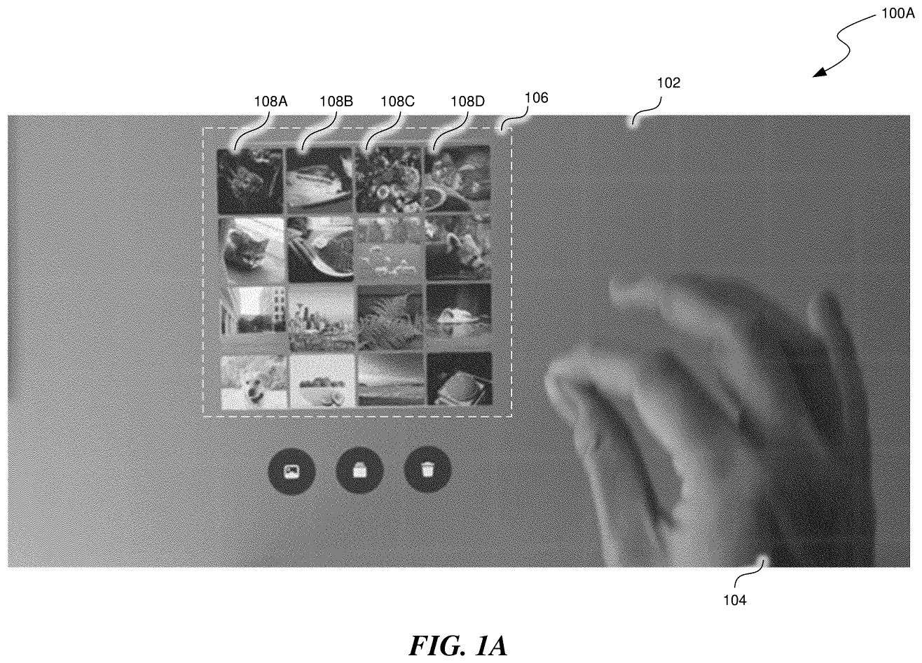

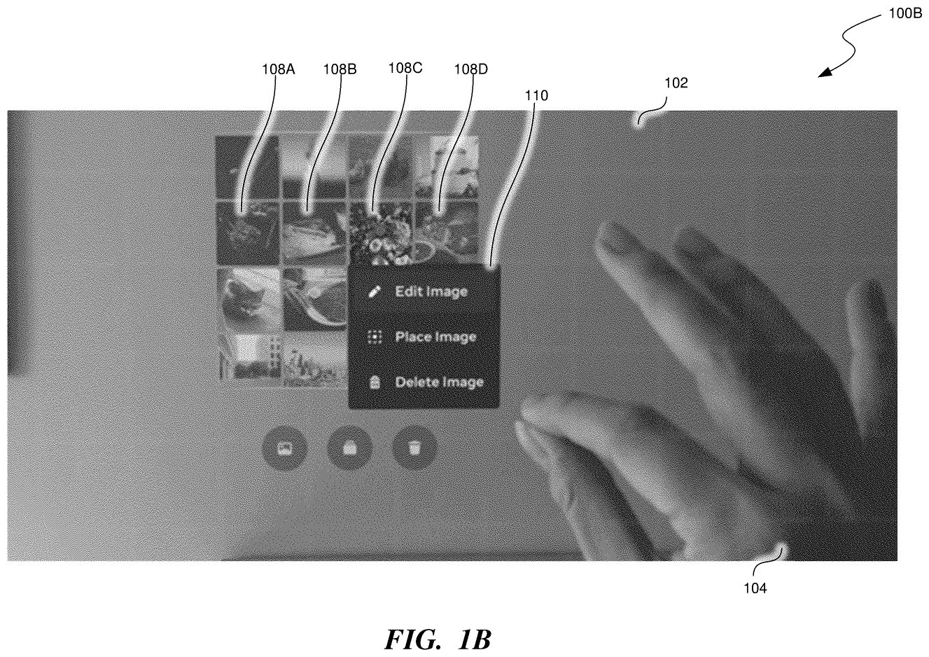

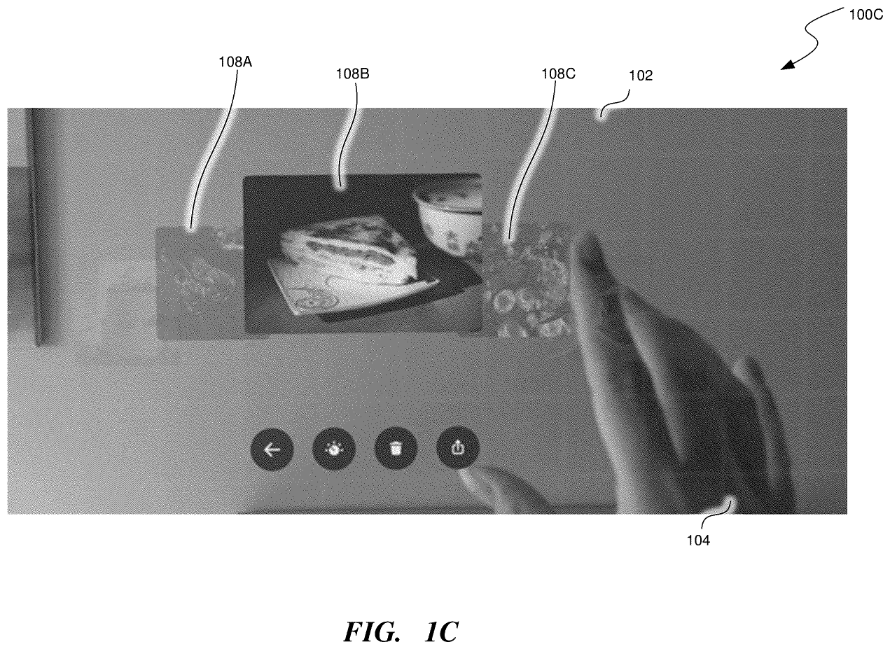

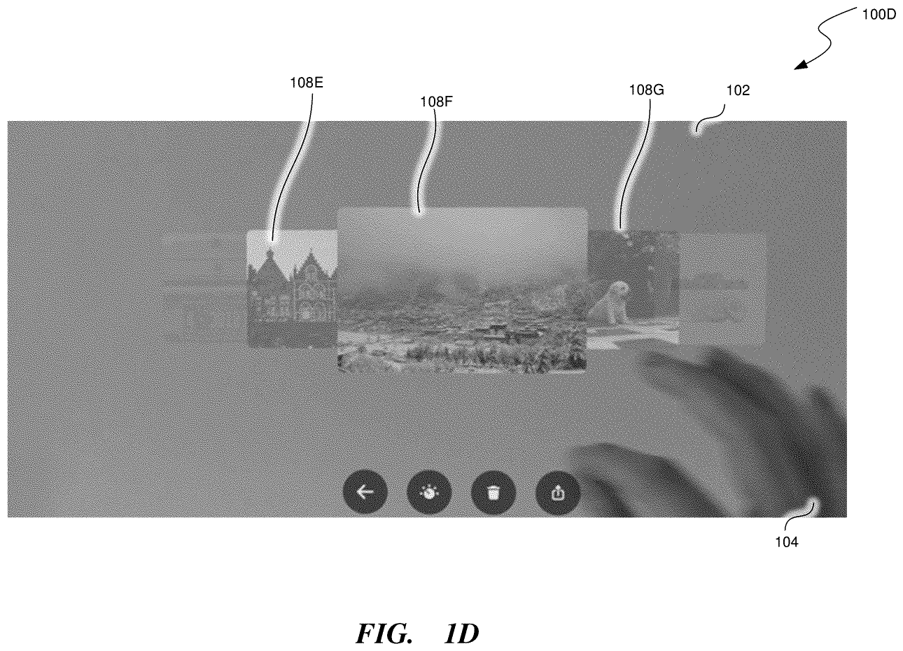

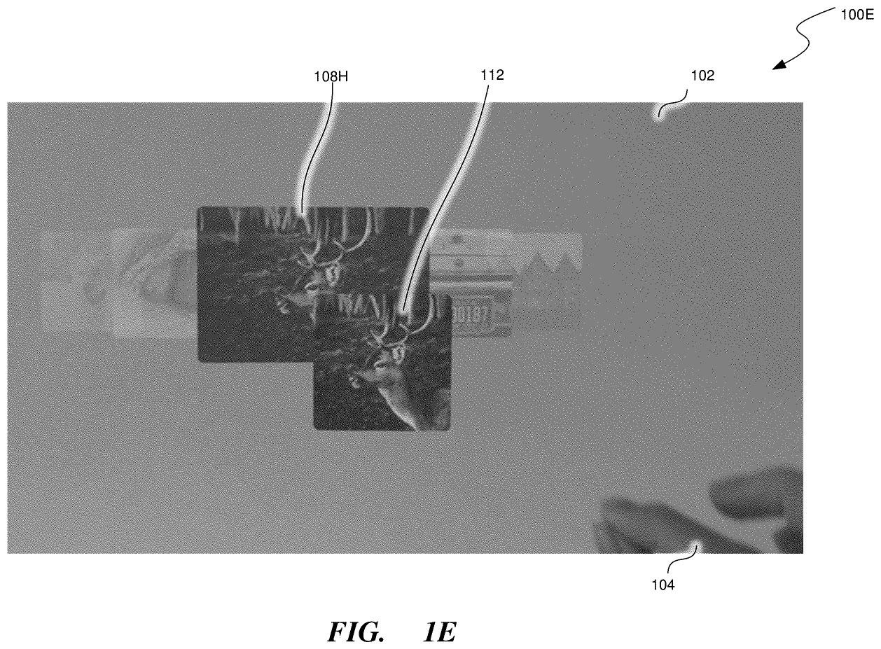

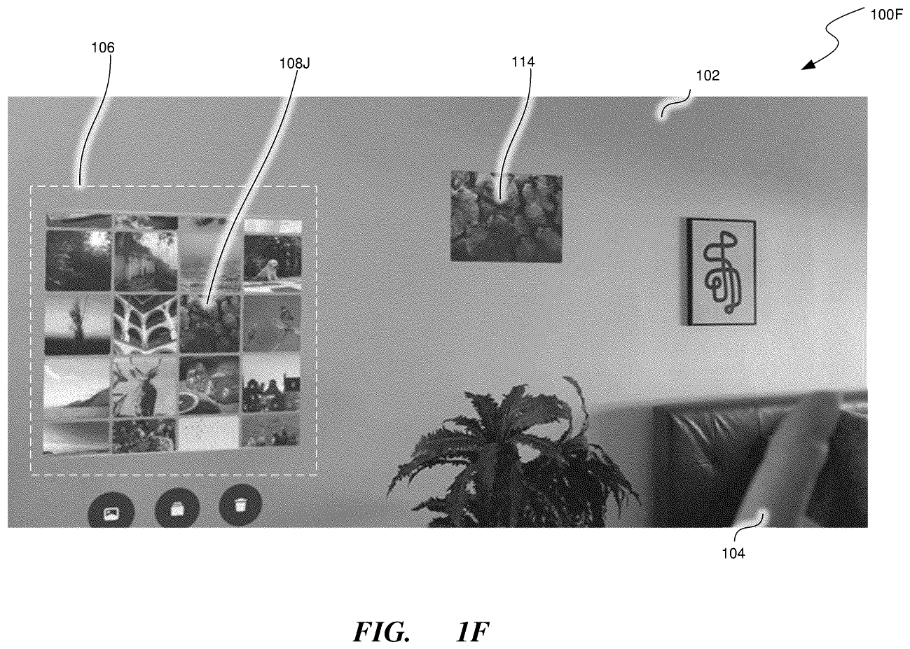

FIG. 1A is a conceptual diagram of an example view 100A, from an XR device, of a user performing a pinch gesture with her hand 104 and moving her hand 104 up and down to vertically scroll through a photo gallery 106. In other words, the XR device can implement a vertical scroll action through photo gallery 106 based on an interaction comprising a pinch gesture (i.e., bringing together the index finger and the thumb), followed by a y-direction movement of the pinch gesture. In some implementations, inertia can be applied to the y-direction motion, such that the vertical scroll feels natural and responsive to the user. Photo gallery 106 is an exemplary library of virtual objects, the virtual objects including photos, such as photos 108A-108D, for example. Photo gallery 106 can be overlaid onto a view of a real-world environment 102, such as in mixed reality (MR) or augmented reality (AR). Upon release of the pinch gesture, vertical scrolling of photo gallery 106 can cease.

FIG. 1B is a conceptual diagram of an example view 100B, from an XR device, of a user performing a pinch-and-hold gesture with her hand 104 to display a menu 110 of options with respect to a particular photo 108C in a photo gallery 106. In other words, the XR device can implement a menu 110 display action based on an interaction comprising a pinch gesture, followed by a holding of the pinch gesture for a threshold amount of time (e.g., 1 second). XR device can display menu 110 with respect to a particular photo 108C, for example, based on the gaze direction of the user toward photo 108C, which can also be captured by the XR device.

The user can scroll up and down to highlight different options in menu 110, without releasing the pinch. If the user releases the pinch, menu 110 can become actionable using gaze and pinch. For example, if the user wants to edit photo 108C, she can gaze at photo 108C and hold a pinch gesture with her hand 104 for a threshold amount of time to display menu 110. The user can then look at the “edit image” option, and perform a “quick pinch” (i.e., a pinch-and-release, in which the pinch is held for less than a threshold amount of time, e.g., less than 1 second) to edit photo 108C.

FIG. 1C is a conceptual diagram of an example view 100C, from an XR device, of a user performing a pinch-and-release gesture with her hand 104 to select a photo 1088 from a photo gallery 106, and view it in a zoomed-in mode. In other words, the XR device can implement a selection action based on an interaction comprising a “quick pinch”, i.e., putting the index finger and the thumb together for less than a threshold amount of time (e.g., less than 0.5 seconds), then separating the index finger and the thumb. Photo 108B in particular can be selected based on the user's gaze direction toward photo 1088 in photo gallery 106, thereby generating view 100C.

In view 100C, selected photo 1088 can be zoomed in relative to its size in photo gallery 106, with previous photo 108A and next photo 108C from photo gallery 106 being displayed on either side of selected photo 108B in a horizontal configuration. In some implementations, selected photo 108B can be displayed in full size and resolution, while prior photo 108A and next photo 108C can be smaller in size, lower in resolution, be dimmed, be differently shaped, and/or be otherwise less prominent than selected photo 1088. From the zoomed-in mode, various actions can be taken using further gestures.

For example, FIG. 1D is a conceptual diagram of an example view 100D, from an XR device, of a user performing a pinch gesture and moving her hand 104 left and right to horizontally scroll through a photo gallery 106 in a zoomed-in mode. In other words, from view 100C of FIG. 1C, the XR device can implement a horizontal scrolling action based on an interaction comprising a pinch-and-hold gesture (i.e., holding the index finger and the thumb together), then moving left and/or right in the x-direction. Upon scrolling, view 100D of FIG. 1D can include photos 108E-108G, with photo 108F displayed in zoomed-in mode. In some implementations, photo 108F, displayed in zoomed-in mode, can adapt to its real aspect ratio when selected, then revert to a square aspect ratio when it is in the background (e.g., as in photo 108E and photo 108G).

Various other actions can be performed while in the zoomed-in mode shown in view 100C of FIG. 1C and view 100D of FIG. 1D. For example, to return to view 100A of FIG. 1A (i.e., to view photo gallery 106), the user can use her hand 104 to swipe down on the current selected photo, e.g., photo 108F of FIG. 1D. In another example, the user can look at another photo (e.g., photo 108E or photo 108G) and make a selection gesture (e.g., a pinch-and-release) to view the previous or next photo in zoomed-in mode.

As another example, FIG. 1E is a conceptual diagram of a view 100E, from an XR device, of a user performing a pinch-and-peel gesture with her hand 104 to peel a copy 112 of a photo 108H from a photo gallery 106 in zoomed-in mode, and place it at a location within a real-world environment 102. In other words, in zoomed-in mode, the XR device can implement a “peeling” action (i.e., a duplication and/or removal of selected photo 108H) based on an interaction comprising a pinch gesture (i.e., holding the index finger and the thumb together), then moving hand 104 toward the user, i.e., in a z-direction. Once copy 112 of photo 108H is peeled from the zoomed-in mode, it can be overlaid onto real-world environment 102 in view 100E, such as on a surface (e.g., a wall) or suspended in the air.

Although shown and described in FIG. 1E as performing a peeling action on photo 108H from a zoomed-in mode, it is contemplated that a similar peeling action can be made from a full view of photo gallery 106. For example, FIG. 1F is a conceptual diagram of a view 100F, from an XR device, of a user performing a pinch-peel-throw gesture with her hand 104, in order to select a photo 108J from a photo gallery 106, and place a peeled copy 114 of photo 108J on a wall within a real-world environment 102. In other words, from photo gallery 106, the XR device can implement a placement action (i.e., overlaying copy 114 into real-world environment 102) based on an interaction comprising a pinch gesture (i.e., holding the index finger and thumb together), a peeling gesture (i.e., moving hand 104 toward the user in a z-direction), then a throw or push gesture toward a location in real-world environment 102, thereby virtually attaching copy 114 to the wall. In some implementations, the XR device can further capture the gaze direction of the user to identify where in real-world environment to place copy 114 of photo 108J. In some implementations, the XR device can determine where to place copy 114 based on the alignment of the gaze direction of the user and a vector representative of the direction of the throw or push gesture.

In some implementations, copy 114 of photo 108J can be automatically placed on a surface (e.g., a wall) by one or more of a variety of methods. In one example, the user can grab copy 114 and drag it by using six degrees of freedom (6DOF) manipulation. Once copy 114 is close to a surface (i.e., within a specified distance threshold), copy 114 can automatically transition to the surface, where the user can reposition it using a further pinch-peel-move interaction. In another example, the user can drag copy 114 via a pinch gesture and gesture toward a surface (e.g., point), which can cause an anchor (e.g., a placeholder) to visually appear on the surface in the direction the user is gesturing. Upon release of the pinch gesture, copy 114 can travel to the surface where the anchor is located. In another example, the user can grab copy 114 using a pinch gesture, and look at a location on a surface where she wants to attach copy 114. After the gaze has been held at that location for a threshold period of time (e.g., 0.25 seconds), the XR device can display a placeholder on the surface at the location where the user is looking. Upon release of the pinch gesture, copy 114 can travel to the surface at the location where the user was looking.

In some implementations, however, it is contemplated that copy 114 does not have to be affixed to a surface. For example, the user can perform a pinch and peeling gesture to grab copy 114, then can move her hand 104 in the x-, y-, and/or z-directions to position copy 114 in real-world environment. Upon release of the pinch gesture without an accompanying throw or push gesture, for example, copy 114 can be positioned in midair without automatically attaching to a wall or other surface.

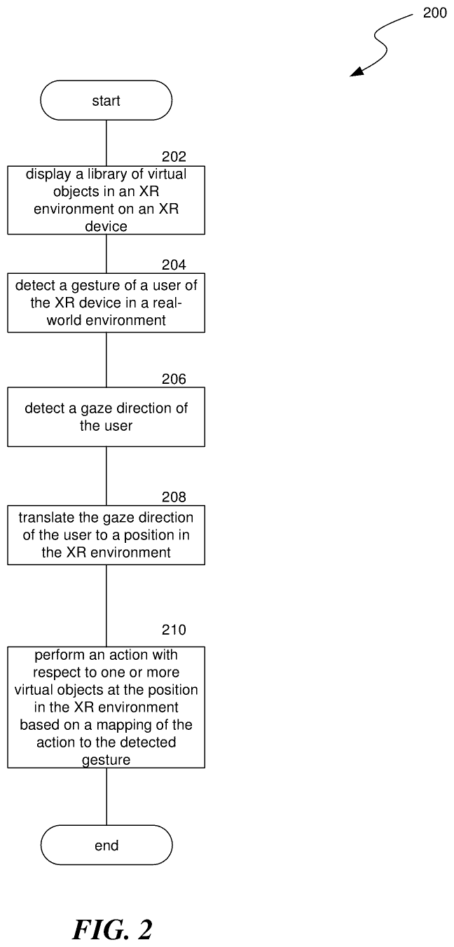

FIG. 2 is a flow diagram illustrating a process 200 used in some implementations for performing an action in an XR environment using gaze and gesture of a user. In some implementations, process 200 can be performed as a response to launching of an XR experience, e.g., an XR application, on an XR device. In some implementations, process 200 can be performed as a response to detection of activation or donning of an XR device by a user. In some implementations, at least a portion of process 200 can be performed by an XR device, such as an XR head-mounted display (HMD). In some implementations, at least of portion of process 200 can be performed by an XR device in operable communication with an XR HMD, such as one or more external processing components. In some implementations, the XR device can be configured to display a mixed reality (MR) and/or augmented reality (AR) experience.

At block 202, process 200 can display a library of virtual objects in an XR environment on an XR device. The XR device can be accessed by a user in a real-world environment. In some implementations, the XR device can be an XR HMD. The library can include any number of two or more virtual objects. The virtual objects can include any visual objects that, in some implementations, can be configured to be overlaid onto a view of the real-world environment of the user, such as in an MR or AR experience. However, in some implementations, it is contemplated that the virtual objects can be configured to be overlaid onto a fully artificial view, such as in a virtual reality (VR) experience. In some implementations, the virtual objects can be static or dynamic, and can be two-dimensional (2D) or three-dimensional (3D). For example, the virtual objects can include photographs, videos, animations, avatars, and/or any other elements of an XR environment, such as virtual animals, virtual furniture, virtual decorations, etc.

At block 204, process 200 can detect one or more gestures of the user in the real-world environment. In some implementations, process 200 can detect a gesture of the user via one or more cameras integral with or in operable communication with the XR device. For example, process 200 can capture one or more images of the user's hand and/or fingers in front of the XR device while making a particular gesture. Process 200 can perform object recognition on the captured image(s) to identify a user's hand and/or fingers making a particular gesture (e.g., holding up a certain number of fingers, pointing, snapping, tapping, pinching, moving in a particular direction, etc.). In some implementations, process 200 can use a machine learning model to identify the gesture from the image(s). For example, process 200 can train a machine learning model with images capturing known gestures, such as images showing a user's hand making a fist, a user's finger pointing, a user's hand making a pinch gesture, a user making a sign with her fingers, etc. Process 200 can identify relevant features in the images, such as edges, curves, and/or colors indicative of fingers, a hand, etc., making a particular gesture. Process 200 can train the machine learning model using these relevant features of known gestures. Once the model is trained with sufficient data, process 200 can use the trained model to identify relevant features in newly captured image(s) and compare them to the features of known gestures. In some implementations, process 200 can use the trained model to assign a match score to the newly captured image(s), e.g., 80%. If the match score is above a threshold, e.g., 70%, process 200 can classify the motion captured by the image(s) as being indicative of a particular gesture. In some implementations, process 200 can further receive feedback from the user regarding whether the identified gesture was correct, and update the trained model accordingly.

In some implementations, process 200 can detect the gesture of the user via one or more sensors of an inertial measurement unit (IMU), such as an accelerometer, a gyroscope, a magnetometer, a compass, etc., that can capture measurements representative of motion of the user's fingers and/or hands. In some implementations, the one or more sensors can be included in one or more controllers being held by the user or wearable devices being worn by the user (e.g., a smart wristband), with the devices being in operable communication with the XR device. The measurements of the one or more sensors may include the non-gravitational acceleration of the device in the x, y, and z directions; the gravitational acceleration of the device in the x, y, and z directions; the yaw, roll, and pitch of the device; the derivatives of these measurements; the gravity difference angle of the device; and the difference in normed gravitational acceleration of the device. In some implementations, the movements of the hands and/or fingers may be measured in intervals, e.g., over a period of 5 seconds.

For example, when motion data is captured by a gyroscope and/or accelerometer in an IMU of a controller, process 200 can analyze the motion data to identify features or patterns indicative of a particular gesture, as trained by a machine learning model. For example, process 200 can classify the motion data captured by the controller as a pinching motion based on characteristics of the device movements. Exemplary characteristics include changes in angle of the controller with respect to gravity, changes in acceleration of the controller, etc.

Alternatively or additionally, the device movements may be classified as particular gestures based on a comparison of the device movements to stored movements that are known or confirmed to be associated with particular gestures. For example, process 200 can train a machine learning model with accelerometer and/or gyroscope data representative of known gestures, such as pointing, snapping, waving, pinching, moving in a certain direction, opening the fist, tapping, holding up a certain number of fingers, clenching a fist, spreading the fingers, snapping, etc. Process 200 can identify relevant features in the data, such as a change in angle of a controller within a particular range, separately or in conjunction with movement of the controller within a particular range. When new input data is received, i.e., new motion data, process 200 can extract the relevant features from the new accelerometer and/or gyroscope data and compare it to the identified features of the known gestures of the trained model. In some implementations, process 200 can use the trained model to assign a match score to the new motion data, and classify the new motion data as indicative of a particular gesture if the match score is above a threshold, e.g., 75%. In some implementations, process 200 can further receive feedback from the user regarding whether an identified gesture is correct to further train the model used to classify motion data as indicative of particular gestures.

Alternatively or additionally, process 200 can detect the gesture of the user via one or more wearable electromyography (EMG) sensors, such as an EMG band worn on the wrist of the user. In some implementations, the EMG band can capture a waveform of electrical activity of one or more muscles of the user. Process 200 can analyze the waveform captured by the one or more EMG sensors worn by the user by, for example, identifying features within the waveform and generating a signal vector indicative of the features. In some implementations, process 200 can compare the signal vector to known gesture vectors stored in a database to identify if any of the known gesture vectors matches the signal vector within a threshold, e.g., is within a threshold distance of a known gesture vector (e.g., the signal vector and a known gesture vector have an angle therebetween that is lower than a threshold angle). If a known gesture vector matches the signal vector within a threshold, process 200 can determine the gesture associated with the vector, e.g., from a look-up table.

At block 206, process 200 can detect a gaze direction of the user. Process 200 can capture the gaze direction of the user using a camera or other image capture device integral with or proximate to the XR device within image capture range of the user. For example, process 200 can apply a light source (e.g., one or more light-emitting diodes (LEDs)) directed to one or both of the user's eyes, which can cause multiple reflections around the cornea that can be captured by a camera also directed at the eye. Images from the camera can be used by a machine learning model to estimate an eye position within the user's head. In some implementations, process 200 can also track the position of the user's head, e.g., using cameras that track the relative position of an XR HMD with respect to the world, and/or one or more sensors of an IMU in an XR HMD, such as a gyroscope and/or compass. Process 200 can then model and map the eye position and head position of the user relative to the world to determine a vector representing the user's gaze through the XR HMD.

At block 208, process 200 can translate the gaze direction of the user to a position in the XR environment. In some implementations, process 200 can determine the position in the XR environment by detecting the direction of the eyes of the user relative to one or more virtual objects and/or relative to the library of virtual objects. For example, process 200 can determine whether the gaze direction is directed at a location assigned to a particular virtual object displayed on the XR device. Process 200 can make this determination by detecting the direction of the eyes of the user relative to the virtual location of the virtual object. For example, process 200 can determine if the gaze direction, as a vector, passes through an area of the XR device's display showing a virtual object, and/or can compute a distance between the point the vector gaze direction passes through the XR device's display and the closest point on the display showing the virtual object

In some implementations, process 200 can determine the position in the XR environment by detecting the direction of the eyes of the user relative to one or more physical objects in the real-world environment. In some implementations, process 200 can determine whether the gaze direction is directed at a physical object displayed on the XR device by detecting the direction of the eyes of the user relative to the virtual location on the XR device of the physical object. For example, process 200 can determine if the gaze direction, as a vector, pass through an area of the XR device's display showing a physical object, and/or can compute a distance between the point the vector gaze direction passes through the XR device's display and the closest point on the display showing the physical object.

At block 210, process 200 can perform an action with respect to one or more virtual objects, in the library of virtual objects, at the position in the XR environment, based on a mapping of the action to the detected gesture. For example, once the gesture of the user is identified, process 200 can query a database and/or access a lookup table mapping particular gestures and/or series of gestures to particular actions. For example, a pinching motion followed by movement of the hand in the y-direction (i.e., up and/or down) can trigger a scrolling action through the library of virtual objects starting at the position in the XR environment identified via gaze direction. In another example, a pinching motion that is released within a threshold amount of time (e.g., less than 0.3 seconds) can trigger a selection of a virtual object at the position in the XR environment, and/or cause the XR device to zoom in on the virtual object. In another example, a pinching motion that is held for a threshold amount of time (e.g., greater than 0.6 seconds) can trigger a menu pop-up to be displayed on the XR device. In another example, a pinching motion followed by movement of the hand in the z-direction toward the user can trigger peeling of a virtual object at the position in the XR environment, and, in some implementations, further movement of the hand and release of the pinch motion at a new position in the XR environment can place the peeled virtual object at the new location.

Aspects of the present disclosure are directed to generating an artificial reality (XR) tutorial from a three-dimensional (3D) video. Some implementations can render the 3D video, which can have embedded data indicating timing, positioning, sequencing, etc., of movements of a person, avatar, or virtual object within the 3D video. Some implementations can extract the embedded data, and generate the XR tutorial by translating the data into movements for a user of an XR device in the real-world environment. Some implementations can then overlay a guide correlated to the movements onto a view of the real-world environment shown on the XR device, such as in augmented reality (AR) or mixed reality (MR).

For example, an XR device can display a 3D video of a person playing a song on the piano. A user of the XR device can select an option to show him how to play the song on the piano. The XR device can review the 3D video and determine a movement pattern of the pianist, e.g., movements and positioning of the pianist's fingers while she's playing the song at particular times. The XR device can translate this movement pattern into visual markers illustrating the movement pattern. Finally, the XR device can cause the visual markers (e.g., arrows) to be shown to the user of the XR device, overlaid on a physical or virtual piano, that project finger placement by indicating where and when to press keys on the piano to play the song.

Thus, some implementations can turn passive consumption of a 3D video into assisted learning of an activity by leveraging the benefits of artificial reality. In some implementations, a user can share learning of the activity with other users for entertainment, to inspire others, to feel closer to others, or to share a common interest. Some implementations provide an enhanced user experience with intuitive manipulation and interactions with virtual objects that crossover into the real world, and provide educational benefits not limited to passive entertainment. Some implementations can be performed solo or as a multiplayer experience at the user's own pace, thereby catering to different experience levels of different users in various activities.

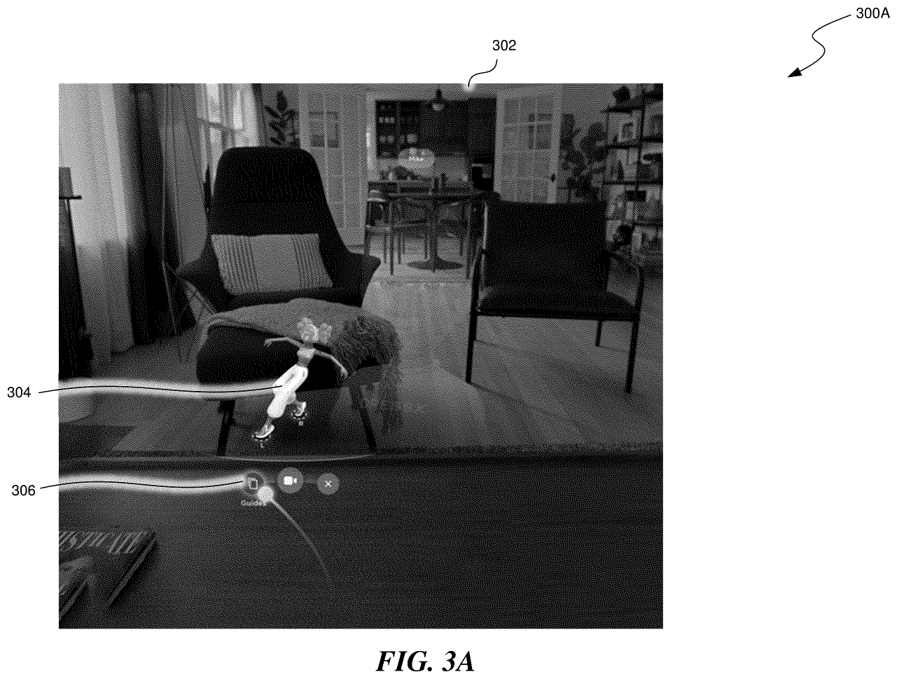

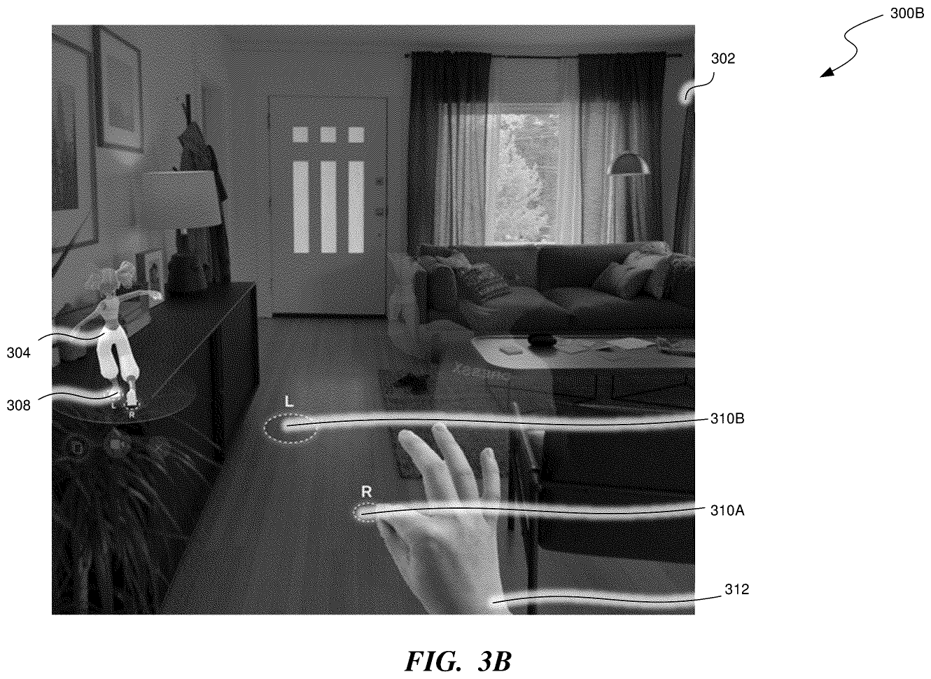

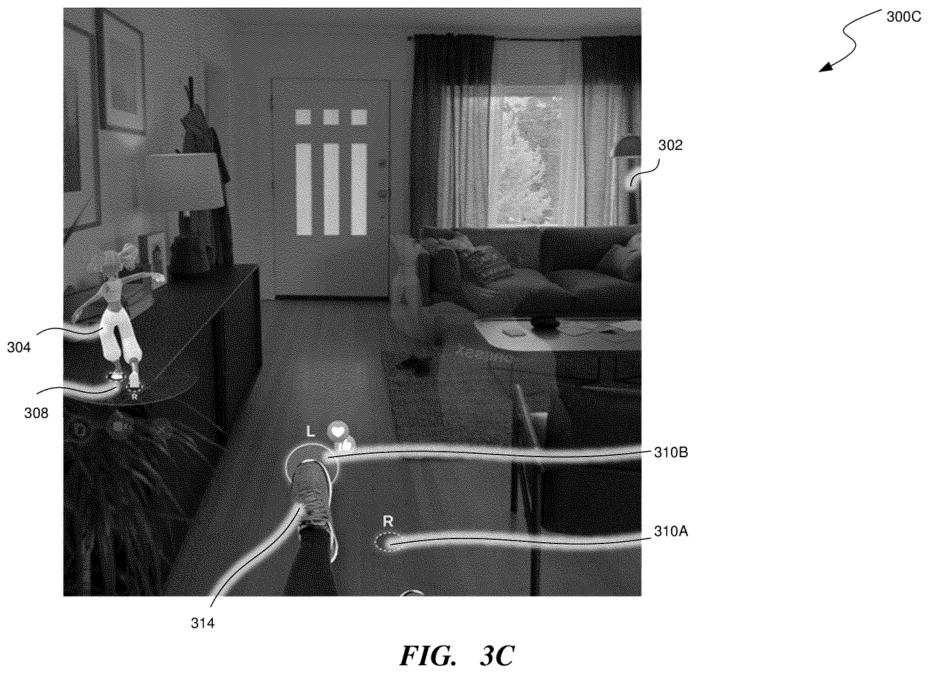

FIG. 3A is a conceptual diagram of an example view 300A on an artificial reality (XR) device of an avatar 304 dancing in a three-dimensional (3D) video with an option 306 to turn a guide on. Avatar 304 can be overlaid on a view of real-world environment 302, such as in an augmented reality (AR) or mixed reality (MR) experience. The XR device can be, for example, an XR head-mounted display (HMD). For example, a user of the XR device can view a 3D hip hop video on the XR device, and determine that she wants to learn the hip hop dance. The user can select option 306 to turn the guide on to learn the hip hop dance, e.g., using her hand as captured by one or more cameras integral with or in operable communication with the XR device, using a controller in operable communication with the XR device via a ray casted into the XR environment, etc.

FIG. 3B is a conceptual diagram of an example view 300B on an artificial reality (XR) device of a user peeling off a guide 308 from an avatar 304 and placing the guide 310A, 310B on a floor in a real-world environment 302. By selecting option 306 from view 300A in FIG. 3A, view 300B can be generated to include avatar 304 having guide 308. A user of the XR device can use her hand 312 to hover over guide 308 on avatar 304 and perform a gesture, e.g., a pinch gesture, to grab the guide. The user can then move hand 312 over the floor in real-world environment 302 and release the pinch gesture to drop a corresponding guide 310A, 310B onto the floor. Some implementations can perform spatial projection mapping to project guide 310A, 310B into real-world environment 302.

FIG. 3C is a conceptual diagram of an example view 300C on an artificial reality (XR) device of a user following a guide 310A, 310B to perform a dance alongside an avatar 304 from a three-dimensional (3D) video. After the user of the XR device peels off guide 308 and places corresponding guide 310A, 310B on the floor in real-world environment 302, as shown in FIG. 3B, the user can follow guide 310A, 310B to perform the hip hop dance alongside avatar 304. For example, the user can place her left foot 314 onto guide 310B, and her right foot (not shown) onto guide 310A. As the hip hop dance progresses, guide 310A, 310B can change to reflect the foot placement of avatar 304 in performing the dance. In some implementations, the hip hop dance can have corresponding audio, such as a song to which avatar 304 is dancing.

From view 300C, the user can toggle between pausing and playing the hip hop dance performed by avatar 304, such that the user can follow guide 310A, 3108 at her own pace. In some implementations, the user can slow down, speed up, rewind, or fast forward the hip hop dance performed by avatar 304, which can cause corresponding changes in guide 310A, 3108. In some implementations, one or more other users on other XR devices can view the user learning and/or performing the hip hop dance and cheer her on, such as in an audience mode. In some implementations, one or more other users on other XR devices can also participate in learning the hip hop dance with the user of the XR device in their own respective real-world environments at the same or different paces.

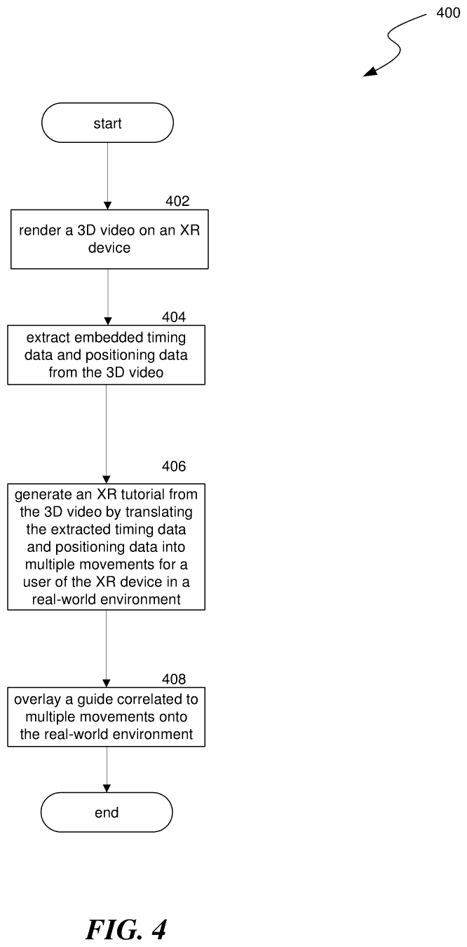

FIG. 4 is a flow diagram illustrating a process 400 used in some implementations for generating an artificial reality (XR) tutorial from a three-dimensional (3D) video. In some implementations, process 400 can be performed as a response to a user request to render a 3D video. In some implementations, process 400 can be performed as a response to a user request to generate a guide based on a 3D video. In some implementations, at least a portion of process 400 can be performed by an XR device, such as an XR head-mounted display (HMD). In some implementations, at least a portion of process 400 can be performed by one or more other XR devices in operable communication with an XR HMD, such as external processing components. In some implementations, the XR device can be an augmented reality (AR) or mixed reality (MR) device.

At block 402, process 400 can render the 3D video on an XR device. The 3D video can be embedded with data, such as timing data, positioning data, sequencing data, lighting data, spatial data, location data, distance data, movement data, etc. The 3D video can include animate objects, such as people or avatars, that have particular movement patterns. The movement patterns can be, for example, dance moves, playing an instrument, performing a repair procedure, etc. In some implementations, the 3D video can be a reel, such as a short video clip from which a creator can edit, sound dub, apply effects, apply filters, etc. In some implementations, the 3D video can be a reel posted to a social media platform.

At block 404, process 400 can extract the embedded data from the 3D video. The embedded data can be data needed to render the 3D video on the XR device. In some implementations, the embedded data in the 3D video can be sufficient to generate a tutorial; thus, additional data need not be generated based on the 3D video (i.e., skipping block 406). Process 400 can extract the embedded data by, for example, analyzing metadata objects associated with the 3D video to identify data needed to translate the 3D video into movements in a real-world environment, such as timing data, location data, spatial data, etc. In other implementations, process 400 can generate the metadata by analyzing the 3D video, e.g., identifying key frames where significant moves or changes in direction, pauses, etc. are made. In some cases, process 400 can map a kinematic model to an avatar or user shown in the 3D video, by identifying body parts shown in the 3D video to corresponding parts of the kinematic model. Then the movements of the mapped kinematic model can be used to determine how the avatar or user is moving across various video frames.

In some implementations, process 400 can identify which movements are correlated to which body parts using a machine learning model. For example, process 400 can train a machine learning model with images capturing known hands, fingers, legs, feet, etc., such as images showing various users' appendages in various positions. Process 400 can identify relevant features in the images, such as edges, curves, and/or colors indicative of hands, fingers, legs, feet, etc. Process 400 can train the machine learning model using these relevant features of known body parts and position/pose information. Once the model is trained with sufficient data, process 400 can use the trained model to identify relevant features for 3D videos, which can also provide position information.

At block 406, process 400 can generate the XR tutorial from the 3D video by translating the extracted data into movements for a user of the XR device in a real-world environment. For example, process 400 can determine which movements are correlated to which body parts of a user of the XR device, and apply those movements to a body template. In some implementations, process 400 can generate the XR tutorial by applying artificial intelligence (AI) techniques and/or machine learning techniques to correlate location data in the XR environment of the person or avatar in the 3D video to corresponding locations in the real-world environment.

Process 400 can associate the identified body parts in the 3D video with a body template in the XR environment representing the user of the XR device. In some implementations, process 400 can associate the body parts with the body template by mapping the identified features of the body parts to corresponding features of the body template. For example, process 400 can map identified fingers in the 3D video to the virtual fingers of the body template, identified palm to virtual palm of the body template, etc. In some implementations, process 400 can scale and/or resize captured features of the body parts in the 3D video to correlate to the body template, which can, in some implementations, have a default or predetermined size, shape, etc. Process 400 can then determine visual indicators for the user using the extracted data and the body template, such as where the user should place her hand, foot, etc., in the real-world environment corresponding to the movements of the body template.

At block 408, process 400 can overlay a guide correlated to the multiple movements onto the real-world environment. The guide can include the visual indicators showing the user where to place her hand, foot, fingers, etc., in the real-world environment. For example, the visual indicators can be markers on the floor for a dance tutorial, markers on the floor and in the air for an exercise tutorial, positions on an instrument corresponding to finger placement, locations on a vehicle for a repair tutorial, locations in a home for a home improvement tutorial, etc. Thus, using the guide, the XR tutorial can teach the user how to perform the actions taken in the 3D video by the person or avatar. In some implementations, process 400 can be performed by multiple XR devices simultaneously or concurrently, such that multiple users within an XR environment can see the guide in their respective real-world environment and perform the tutorial together, such as in a multiplayer XR experience.

In some implementations, process 400 can further provide an auditory guide, such as verbal instructions corresponding to the visual guide. In some implementations, process 400 can further provide visual or audible feedback to the user following the guide. For example, process 400 can capture one or more images showing the user following the guide, and determine the position of the user relative to the position of the visual markers at particular times. Process 400 can then provide the user additional instructions, highlight or emphasize a visual marker that is not being followed, provide a score to the user for how well the guide was or is being followed, etc.

Although described herein as being a 3D video, it is contemplated that process 400 can be similarly performed on a two-dimensional (2D) video or a 2D object having embedded 2D positioning data, color data, lighting data, etc. In some implementations, the 2D positioning data can be translated into coordinates in a 3D space based on lighting, shadows, etc. For example, process 400 can obtain a 2D rendering of a painting (either while it is being created or after it is complete), and overlay a guide on a physical canvas in the real-world environment showing the user where and how to recreate the painting on the flat canvas using colors. In another example, process 400 can obtain a 2D rendering of calligraphy while it is being written, and guide the user to position his hand and fingers in a certain manner, to apply a certain amount of pressure, to hold the pen a particular way, etc., in order to recreate the handwriting. In still another example, process 400 can obtain a piece of 2D sheet music, and translate the notes of the sheet music to 3D finger placement on an instrument.

To achieve self-presence in an XR environment, participants are represented by visual representations (e.g., a video, an avatar, a codec avatar). Visual representation within XR environments can affect participants' perception of self and others, which can affect the overall immersive experience and how participants behave in the XR environment. For example, during an XR environment session (e.g., an XR video call), a caller user may not know which visual representation of herself is being presented to the recipient caller. If the caller user is being shown as an avatar, the caller user may not be concerned about her real-life physical state. On the other hand, if a real-life visual representation (e.g., video) is being presented to the recipient caller, the caller user may want to adjust her physical appearance (e.g., hair, glasses) or change her visual representation prior to revealing the visual representation to the recipient caller. Accordingly, control over self-presence in XR environments without creating XR environment distractions is desirable.

The aspects described herein give participants control over self-presence in XR environments by generating a self-view image allowing the participants to see their visual representation as presented to other participants. The self-view image is triggered upon detecting a self-view gesture. For example, the caller user can hold up a flat hand gesture and gaze at the palm of her hand to trigger the self-view image. This gesture can resemble the caller user holding up a mirror (i.e., her hand) and looking at the mirror. The self-view image is generated via the caller user's XR device along with control options. The control options allow the caller user to manipulate the appearance of the self-view image on her view and/or manipulate the self-view image on the recipient caller's view. The self-view gesture and self-view image will now be discussed in more detail.

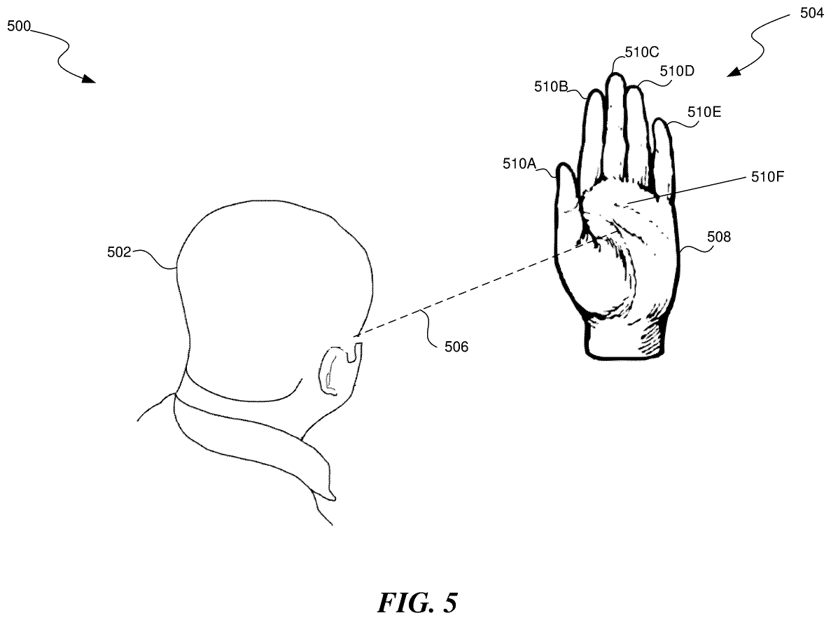

FIG. 5 is a conceptual diagram of an example 500 showing a caller user 502 triggering a self-view image (shown in FIGS. 3-4) with a self-view gesture 504 and a gaze 506 directed to (e.g., intersecting with) the self-view gesture 504. In some implementations, the self-view gesture 504 resembles a mirror being held by the caller user 502 and the gaze 506 resembles the caller user 502 looking at the mirror. More specifically, the self-view gesture 504, created by a hand 508 of the caller user 502 includes a flat hand with a thumb next to the flat hand. The palm of the flat hand is facing the caller user 502. As seen in FIG. 5, the self-view gesture 504 includes an index finger 5106, a middle finger 510C, a ring finger 510D, and a pinky finger 510E being extended distally from a palm 510F. The index finger 5108, the middle finger 510C, the ring finger 510D, and the pinky finger 510E are held tightly together with little to no space between the fingers. It is understood that in some implementations, the fingers can be determined to be within a predetermined threshold of the other fingers.

The self-view gesture 504 also includes a thumb 510A next to the palm 510F. As shown in FIG. 5, the thumb 510A is held tightly against the palm 510F. It is understood that in some implementations, the thumb 510A can be determined to be within a predetermined threshold of the palm 510F. The gaze 506 is directed at the self-view gesture 504 so that the gaze 506 intersects with a center of the palm 510F. In some implementations, the intersection point with the self-view gesture 504 can be in a different location, for example, at a distal point of the middle finger 510C.

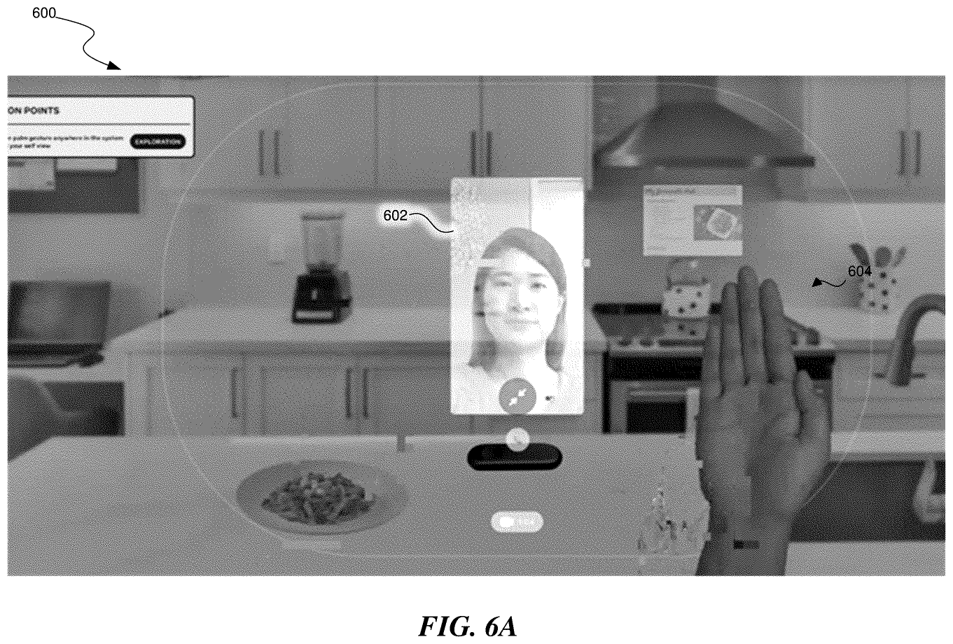

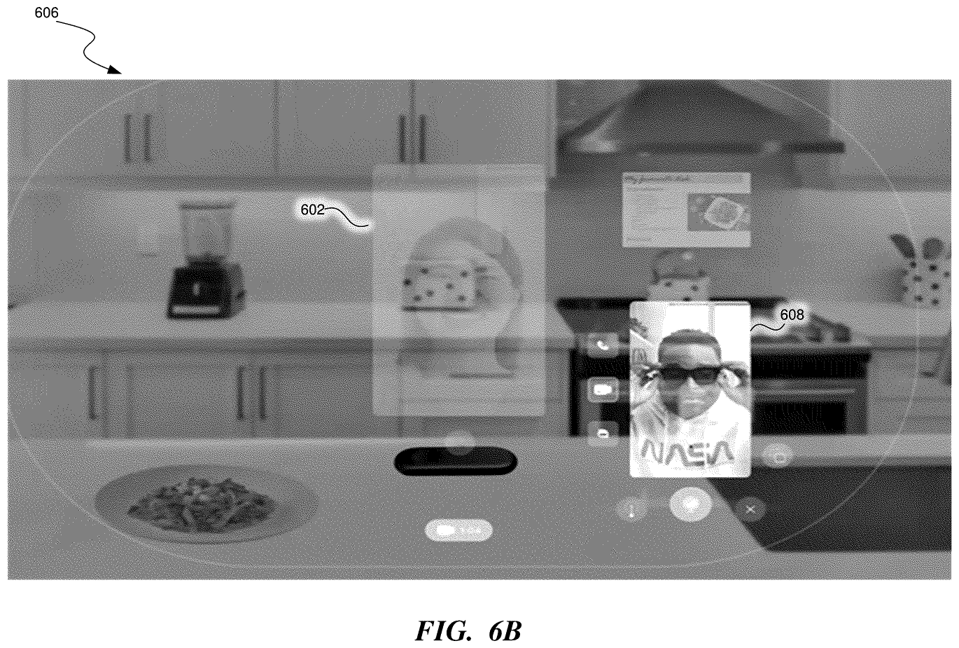

FIG. 6A is a conceptual diagram of an example view 600 in an artificial reality (XR) environment, and more specifically, an XR video call. In this example, the view 600 is presented on a first XR device associated with the caller user (not shown) during the XR call. A representation 602 of a recipient user (not shown) is displayed on the view 600. A self-view gesture 604 created by the caller user is also shown in the view 600. Upon detecting a gaze directed to the self-view gesture 604 (like the gaze shown in FIG. 1), a self-view image feature is triggered, which will now be described in more detail with FIG. 6B.

FIG. 6B is a conceptual diagram of an example view 606 in response to the detected gesture shown in FIG. 6A. Accordingly, responsive to detecting the self-view gesture 604 and a gaze of the caller user directed to the self-view gesture 604, a self-view image 608 is rendered the view 606 via the first XR device associated with the caller user, and thus, viewable by the caller user. The self-view image 608 shows the caller user how the caller user is being represented to the recipient caller in real-time. In FIG. 6B, the self-view image 608 is a video of the caller user, however, it is understood that the self-view image 308 can be any type of representation (e.g., avatar). The self-view image 608 allows the caller user to understand her real-time appearance and control her representation either by physical real adjustments (e.g., adjusting eyeglasses, combing hair) or virtual adjustments (e.g., changing a type of representation, adding filters, controlling placement of the self-view image).

Accordingly, various controls are also shown on the view 606 with the self-view image 608 allowing the caller user to interact with the self-view image 608, control the representation of the caller user to the recipient user, and control other functions of the XR video call. For example, the caller user could add a filter, change a type of representation either before revealing her representation to the recipient caller or in real-time during the XR video call. The caller user can hide, resize, and move the self-view image 608. Additional examples will now be described.

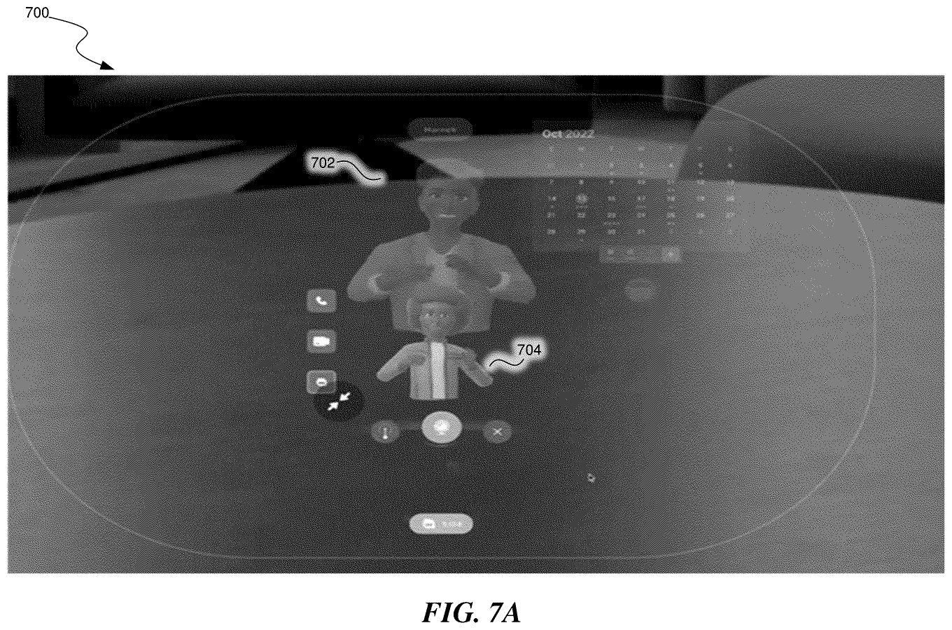

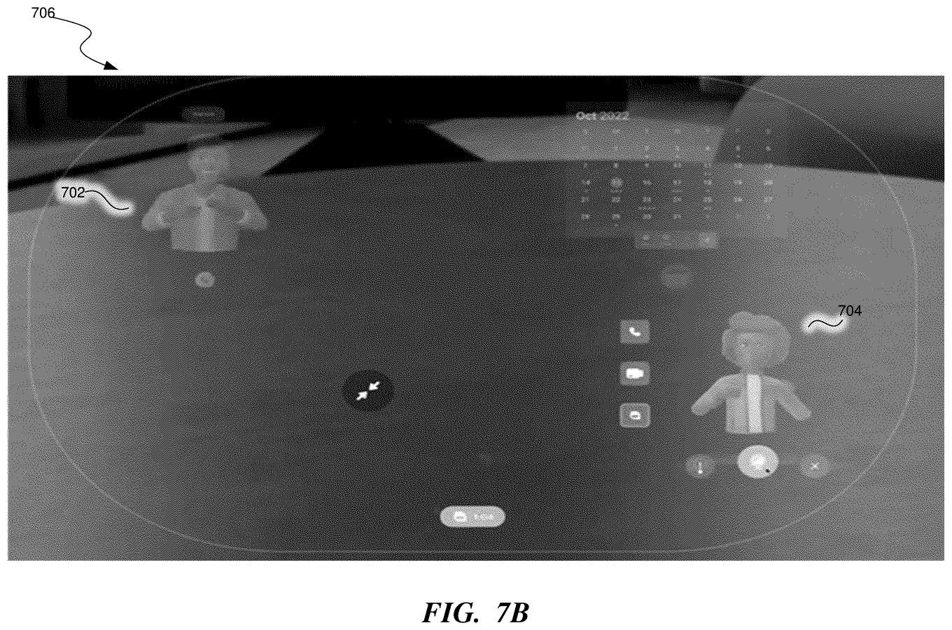

FIG. 7A is a conceptual diagram of an example view 700 shown via a first XR device associated with a user caller. Here, a representation 702 of a recipient user is shown as an avatar and a self-view image 704 of the caller user is shown as an avatar. The caller user can interact with the view 700 to control (e.g., move, hide, resize) a representation of the caller user and/or the self-view image 704. For example, FIG. 7B shows an example view 706 after the caller user interacts with the view 700 of FIG. 7A. As shown in FIG. 7B, the representation 702 of the recipient caller has been moved to the upper left side of the view 706. Additionally, the self-view image 704 has been moved to the lower right side of the view 706.

In some implementations, the caller user's control of objects on the XR view displayed by the first XR device associated with the caller user may or may not be reciprocated on an XR view (not shown) displayed by a second XR device associated with the recipient user. For example, the caller user may control the appearance (e.g., type of representation, position, size) of the self-view image 704 as presented on the XR view displayed by the first XR device associated with the caller user only (i.e., the XR view displayed by the second XR devices associated with the recipient user is not changed). In another example, the change and/or control of the appearance may also be presented on the XR view displayed by the second XR device associated with the recipient user.

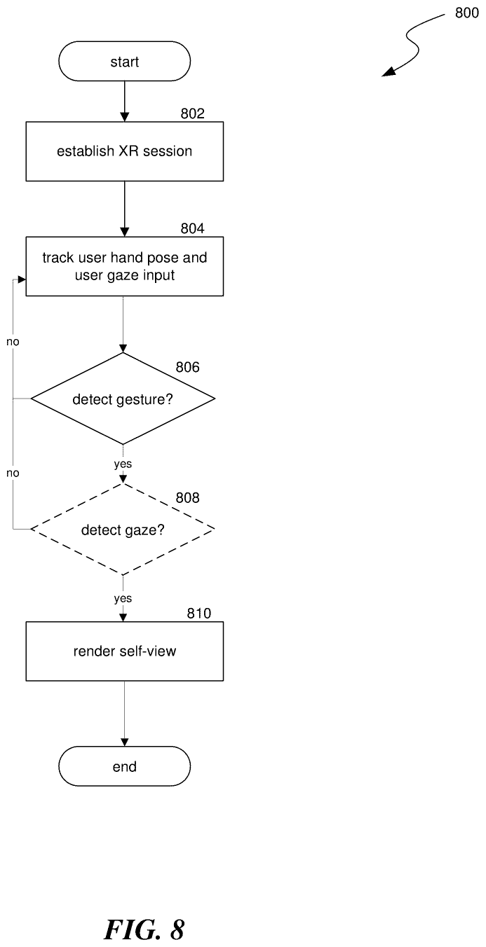

FIG. 8 is a flow diagram illustrating a process 800 used in some implementations for artificial reality self-view. In some implementations, the process 800 can be performed as a response to initiating an XR video call. In some implementations, the process 800 can be performed on demand in response to detecting the self-view gesture. In other implementations, the process 800 can be performed ahead of time (e.g., on a schedule). In various implementations, process 800 can be performed on an XR device or on a server system supporting such a device (e.g., where the XR device offloads compute operations to the server system).

At block 802, process 800 can establish an artificial reality (XR) environment session, for example, an XR video call. The XR environment session includes bidirectional communication between a first artificial reality device associated with a caller user (i.e., user initiating the XR video call) and a second artificial reality device associated with a recipient user (i.e., user receiving the XR video call). In some cases, during the XR video call a caller user may wish to represent herself as a video (i.e., providing a 2D or 2.5D view of the caller user), an avatar (e.g., an animated or still, sometimes character or fanciful view representing the caller user), a codec avatar or hologram (e.g., a life-like representation that mimics the movements of the caller user in real-time), or another type of representation, to a recipient user. In some cases, the caller user may not be in control (and may not even be aware) of which representation is being shown as the XR device may automatically switch between representation based on factors such as capture quality of the caller user, available bandwidth, batter, or processing power, etc. Further, even if the caller user knows the type of the representation, she may not know at any given moment what the representation looks like to the call recipient. Thus, it can be beneficial for the caller user to have a way to understand what the call recipient is seeing.

At block 804, process 800 can track a user hand pose input of the caller user and a user gaze input of the caller user. More specifically, the process 800 can receive tracked user gaze input and tracked user hand input of the caller user. In various implementations, hand and gaze tracking can be performed using computer vision systems, e.g., trained to take images of the user's hands or eyes and predict whether the hands are making particular gestures or a direction of the eye gaze (which may be done in conjunction with tracking of the artificial reality device to get head pose). In some cases, the hand tracking can be performed with other instrumentation, such as a wristband or glove that can detect user hand pose/gestures. As discussed herein, the tracked user gaze input and the tracked user hand input are used to detect a self-view gesture and trigger a self-view image. The tracked user hand pose input can include hand and/or finger position and/or motion, for example, in relation to the first XR device. The process 800 can also track a user gaze input using eye tracking, head tracking, face tracking, among others. As will be discussed herein, the user gaze input includes an orientation to determine whether a gaze location of the user gaze input is directed at the self-view gesture.

At block 806, process 800 can detect a self-view gesture using the hand pose input. The self-view gesture can include a flat hand with a thumb of the caller user next to the flat hand. As discussed herein with FIG. 1, detecting the flat hand includes determining an index finger, a middle finger, a ring finger, and a pinky finger of the caller user being extended distally from a palm of the caller user. Additionally, detecting the self-view gesture can include detecting the thumb of the caller user is positioned next to the palm of the caller user. It is understood that predictive gesture recognition models can be used to detect the self-view gesture. In various implementations, other gestures can be used as the self-view gestures, such as a palm out with the fingers spread, a fist, etc. If the process 800 detects the self-view gesture, the process 800 continues to block 808. Otherwise, if the process 800 does not detect the self-view gesture, the process returns to block 804 to continue tracking the user hand pose input and the user gaze input.

While any block can be removed or rearranged in various implementations, block 808 is shown in dashed lines to indicate there are specific instances where block 808 is skipped. For example, in some cases the system may show the self-view whenever the user makes a particular gesture, whether or not the user is looking at the gesture. At block 808, process 800 can detect whether a gaze location of the user gaze input is directed at the self-view gesture. In some embodiments, the process 800 determines if the gaze location of the user gaze input intersects the palm of the caller user, for example, at a centroid of the palm. In other embodiments, the intersection point with the self-view gesture can be in a different location, for example, at a distal point of the middle finger. If the process 800 detects the gaze location of the caller user is directed at the self-view gesture, the process 800 proceeds to block 810. Otherwise, if the process 800 does not detect the gaze location of the user is directed at the self-view gesture, the process returns to block 804 to continue tracking the user hand pose input and the user gaze input.

In some implementations, other triggers can be in place to start the self-view, such as a verbal command, an interaction with a physical button on the artificial reality device, or an interaction with a virtual UI provided by the artificial reality device.

At block 810, responsive to A) detecting the self-view gesture at block 806 and optionally B) detecting the gaze location of the user gaze input is directed at the self-view gesture at block 808, the process 800 can render a self-view image to the caller user via the first artificial reality device. The self-view image is a representation of the caller user as displayed on the second artificial reality device to the recipient user, as discussed above.

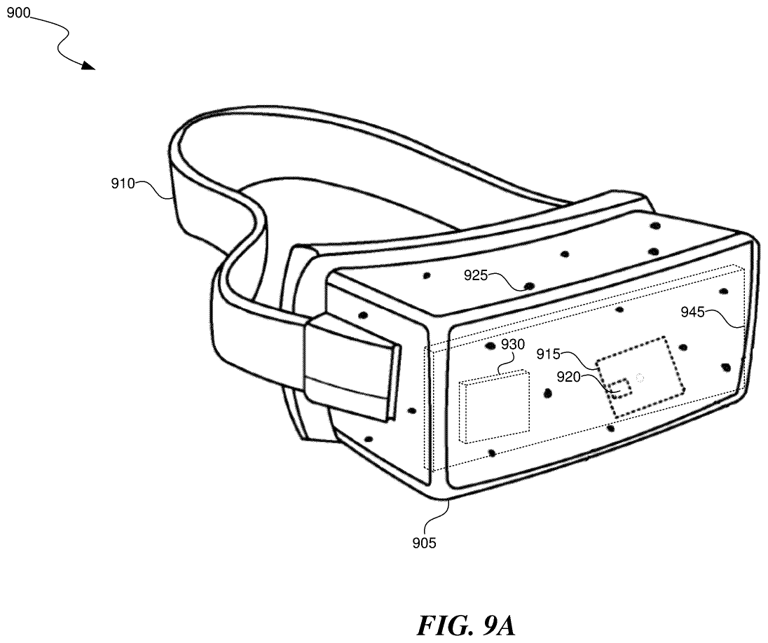

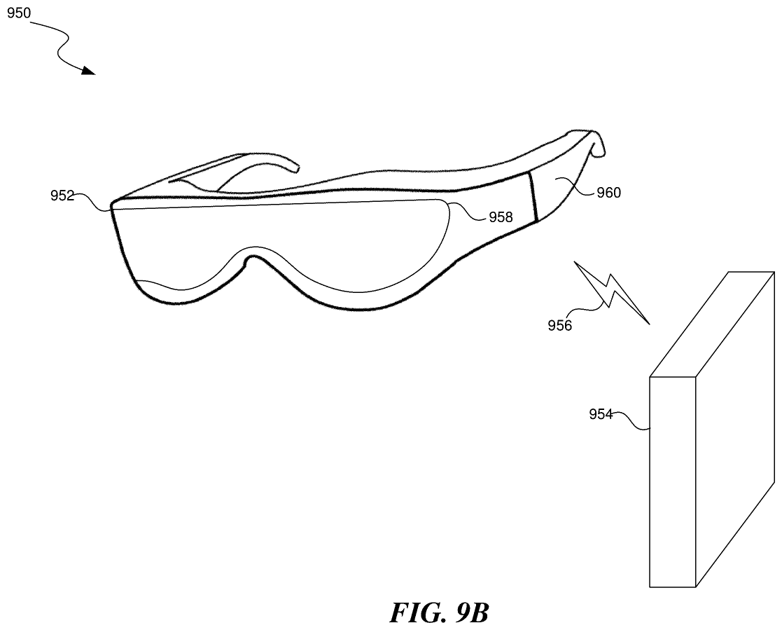

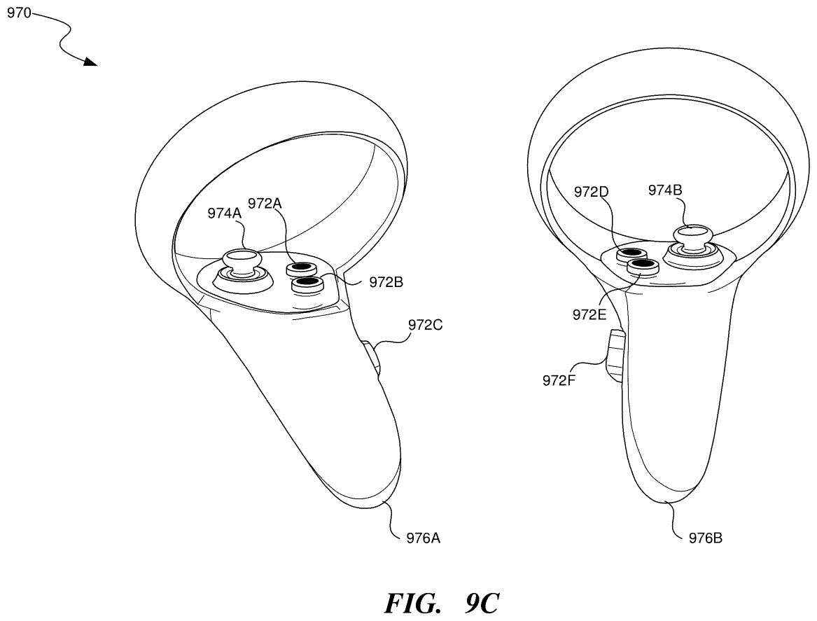

FIG. 9A is a wire diagram of a virtual reality head-mounted display (HMD) 900, in accordance with some embodiments. The HMD 900 includes a front rigid body 905 and a band 910. The front rigid body 905 includes one or more electronic display elements of an electronic display 945, an inertial motion unit (IMU) 915, one or more position sensors 920, locators 925, and one or more compute units 930. The position sensors 920, the IMU 915, and compute units 930 may be internal to the HMD 900 and may not be visible to the user. In various implementations, the IMU 915, position sensors 920, and locators 925 can track movement and location of the HMD 900 in the real world and in an artificial reality environment in three degrees of freedom (3DoF) or six degrees of freedom (6DoF). For example, the locators 925 can emit infrared light beams which create light points on real objects around the HMD 900. As another example, the IMU 915 can include e.g., one or more accelerometers, gyroscopes, magnetometers, other non-camera-based position, force, or orientation sensors, or combinations thereof. One or more cameras (not shown) integrated with the HMD 100 can detect the light points. Compute units 930 in the HMD 900 can use the detected light points to extrapolate position and movement of the HMD 900 as well as to identify the shape and position of the real objects surrounding the HMD 900.

The electronic display 945 can be integrated with the front rigid body 905 and can provide image light to a user as dictated by the compute units 930. In various embodiments, the electronic display 945 can be a single electronic display or multiple electronic displays (e.g., a display for each user eye). Examples of the electronic display 945 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 900 can be coupled to a core processing component such as a personal computer (PC) (not shown) and/or one or more external sensors (not shown). The external sensors can monitor the HMD 900 (e.g., via light emitted from the HMD 900) which the PC can use, in combination with output from the IMU 915 and position sensors 920, to determine the location and movement of the HMD 900.

FIG. 9B is a wire diagram of a mixed reality HMD system 950 which includes a mixed reality HMD 952 and a core processing component 954. The mixed reality HMD 952 and the core processing component 954 can communicate via a wireless connection (e.g., a 60 GHz link) as indicated by link 956. In other implementations, the mixed reality system 950 includes a headset only, without an external compute device or includes other wired or wireless connections between the mixed reality HMD 952 and the core processing component 954. The mixed reality HMD 952 includes a pass-through display 958 and a frame 960. The frame 960 can house various electronic components (not shown) such as light projectors (e.g., LASERs, LEDs, etc.), cameras, eye-tracking sensors, MEMS components, networking components, etc.

The projectors can be coupled to the pass-through display 958, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 954 via link 956 to HMD 952. Controllers in the HMD 952 can convert the image data into light pulses from the projectors, which can be transmitted via the optical elements as output light to the user's eye. The output light can mix with light that passes through the display 958, allowing the output light to present virtual objects that appear as if they exist in the real world.

Similarly to the HMD 900, the HMD system 950 can also include motion and position tracking units, cameras, light sources, etc., which allow the HMD system 950 to, e.g., track itself in 3DoF or 6DoF, track portions of the user (e.g., hands, feet, head, or other body parts), map virtual objects to appear as stationary as the HMD 952 moves, and have virtual objects react to gestures and other real-world objects.

FIG. 9C illustrates controllers 970 (including controller 976A and 976B), which, in some implementations, a user can hold in one or both hands to interact with an artificial reality environment presented by the HMD 900 and/or HMD 950. The controllers 970 can be in communication with the HMDs, either directly or via an external device (e.g., core processing component 954). The controllers can have their own IMU units, position sensors, and/or can emit further light points. The HMD 900 or 950, external sensors, or sensors in the controllers can track these controller light points to determine the controller positions and/or orientations (e.g., to track the controllers in 3DoF or 6DoF). The compute units 930 in the HMD 900 or the core processing component 954 can use this tracking, in combination with IMU and position output, to monitor hand positions and motions of the user. The controllers can also include various buttons (e.g., buttons 972A-F) and/or joysticks (e.g., joysticks 974A-B), which a user can actuate to provide input and interact with objects.

In various implementations, the HMD 900 or 950 can also include additional subsystems, such as an eye tracking unit, an audio system, various network components, etc., to monitor indications of user interactions and intentions. For example, in some implementations, instead of or in addition to controllers, one or more cameras included in the HMD 900 or 950, or from external cameras, can monitor the positions and poses of the user's hands to determine gestures and other hand and body motions. As another example, one or more light sources can illuminate either or both of the user's eyes and the HMD 900 or 950 can use eye-facing cameras to capture a reflection of this light to determine eye position (e.g., based on set of reflections around the user's cornea), modeling the user's eye and determining a gaze direction.

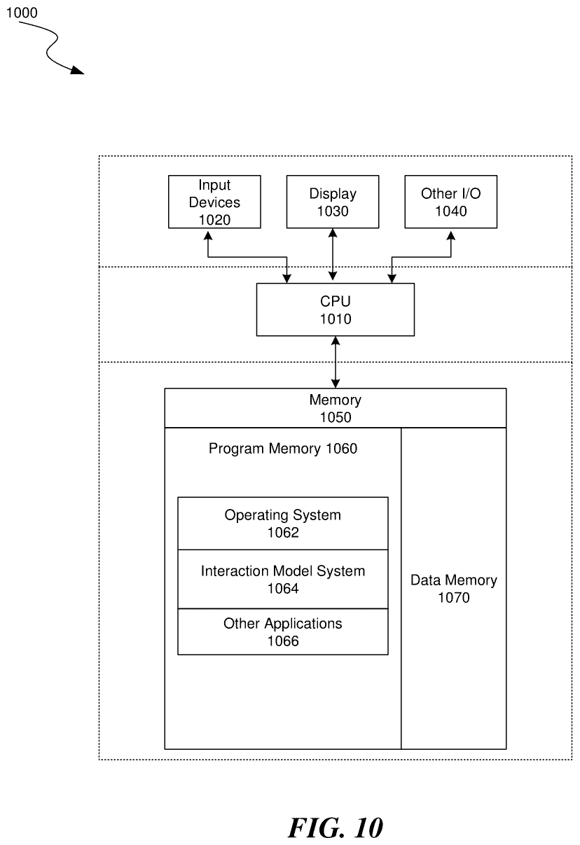

FIG. 10 is a block diagram illustrating an overview of devices on which some implementations of the disclosed technology can operate. The devices can comprise hardware components of a device 1000 as shown and described herein. Device 1000 can include one or more input devices 1020 that provide input to the Processor(s) 1010 (e.g., CPU(s), GPU(s), HPU(s), etc.), notifying it of actions. The actions can be mediated by a hardware controller that interprets the signals received from the input device and communicates the information to the processors 1010 using a communication protocol. Input devices 1020 include, for example, a mouse, a keyboard, a touchscreen, an infrared sensor, a touchpad, a wearable input device, a camera- or image-based input device, a microphone, or other user input devices.

Processors 1010 can be a single processing unit or multiple processing units in a device or distributed across multiple devices. Processors 1010 can be coupled to other hardware devices, for example, with the use of a bus, such as a PCI bus or SCSI bus. The processors 1010 can communicate with a hardware controller for devices, such as for a display 1030. Display 1030 can be used to display text and graphics. In some implementations, display 1030 provides graphical and textual visual feedback to a user. In some implementations, display 1030 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1040 can also be coupled to the processor, such as a network card, video card, audio card, USB, firewire or other external device, camera, printer, speakers, CD-ROM drive, DVD drive, disk drive, or Blu-Ray device.

In some implementations, the device 1000 also includes a communication device capable of communicating wirelessly or wire-based with a network node. The communication device can communicate with another device or a server through a network using, for example, TCP/IP protocols. Device 1000 can utilize the communication device to distribute operations across multiple network devices.

The processors 1010 can have access to a memory 1050 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1050 can include program memory 1060 that stores programs and software, such as an operating system 1062, Interaction Model System 1064, and other application programs 1066. Memory 1050 can also include data memory 1070, which can be provided to the program memory 1060 or any element of the device 1000.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

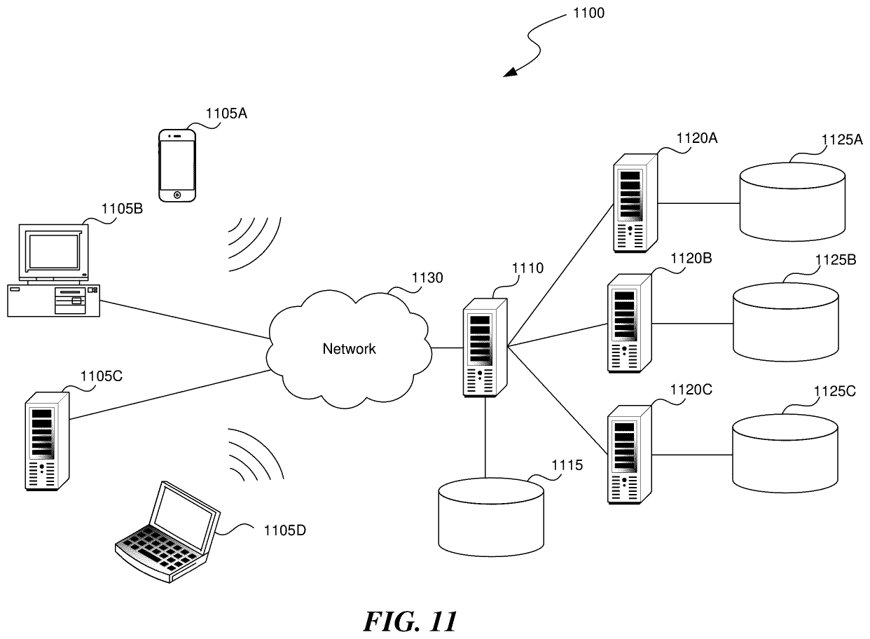

FIG. 11 is a block diagram illustrating an overview of an environment 1100 in which some implementations of the disclosed technology can operate. Environment 1100 can include one or more client computing devices 1105A-D, examples of which can include device 1000. Client computing devices 1105 can operate in a networked environment using logical connections through network 1130 to one or more remote computers, such as a server computing device.

In some implementations, server 1110 can be an edge server which receives client requests and coordinates fulfillment of those requests through other servers, such as servers 1120A-C. Server computing devices 1110 and 1120 can comprise computing systems, such as device 1000. Though each server computing device 1110 and 1120 is displayed logically as a single server, server computing devices can each be a distributed computing environment encompassing multiple computing devices located at the same or at geographically disparate physical locations. In some implementations, each server 1120 corresponds to a group of servers.

Client computing devices 1105 and server computing devices 1110 and 1120 can each act as a server or client to other server/client devices. Server 1110 can connect to a database 1115. Servers 1120A-C can each connect to a corresponding database 1125A-C. As discussed above, each server 1120 can correspond to a group of servers, and each of these servers can share a database or can have their own database. Databases 1115 and 1125 can warehouse (e.g., store) information. Though databases 1115 and 1125 are displayed logically as single units, databases 1115 and 1125 can each be a distributed computing environment encompassing multiple computing devices, can be located within their corresponding server, or can be located at the same or at geographically disparate physical locations.

Network 1130 can be a local area network (LAN) or a wide area network (WAN), but can also be other wired or wireless networks. Network 1130 may be the Internet or some other public or private network. Client computing devices 1105 can be connected to network 1130 through a network interface, such as by wired or wireless communication. While the connections between server 1110 and servers 1120 are shown as separate connections, these connections can be any kind of local, wide area, wired, or wireless network, including network 1130 or a separate public or private network.

In some implementations, servers 1110 and 1120 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for performing an action in an artificial reality environment using gaze and gesture of a user, the method comprising:
displaying a library of virtual objects in the artificial reality environment on an artificial reality device, the artificial reality device being accessed by the user in a real-world environment;
detecting one or more gestures of the user in the real-world environment;
detecting a gaze direction of the user;
translating the gaze direction of the user to a position in the artificial reality environment; and
performing the action with respect to one or more virtual objects, in the library of virtual objects, at the position in the artificial reality environment, based on a mapping of the action to the detected one or more gestures.

2. A method for generating an artificial reality tutorial from a three-dimensional video, the method comprising:
rendering the three-dimensional video on an artificial reality device;
extracting embedded timing data and positioning data from the three-dimensional video;
generating the artificial reality tutorial from the three-dimensional video by translating the extracted timing data and positioning data into multiple movements for a user of the artificial reality device in a real-world environment; and
overlaying a guide correlated to the multiple movements onto the real-world environment.

3. A method for self-view in an artificial reality environment, the method comprising:
tracking a user hand pose input of a caller user in relation to a first artificial reality device;
detecting a self-view gesture using the user hand pose input; and
responsive to detecting the self-view gesture, rendering a self-view image to the caller user via the first artificial reality device.
